(19) United States
(12) Patent Application Publication
(10) Pub. No.: US 2023/0320519 A1
(43) Pub. Date: Oct. 12, 2023

(54) COFFEE MAKER

(71) Applicant: Instant Brands Holdings Inc., Downers Grove, IL (US)

(72) Inventors: Hongyuan WANG, Hangzhou (CN); Yude HAN, Hangzhou (CN); Jiwei WANG, Kanata (CA); Yi QIN, Manotick (CA)

(73) Assignee: Instant Brands Holdings Inc., Downers Grove, IL (US)

(21) Appl. No.: 17/714,369

(22) Filed: Apr. 6, 2022

(51) Int. Cl. A47J 31/44

(52) U.S. Cl. CPC A47J 31/4407; A47J 31/446

(57) ABSTRACT

A coffee maker comprises a body and a brewing device, the body comprises an abutting portion, and the brewing device comprises a receiving apparatus and a top lid movably assembled on the receiving apparatus. The receiving apparatus is provided with a receiving chamber. The top lid is located above the receiving chamber. The brewing device is movable so that the top lid can be switched between a closed state and an opened state. When the brewing device is moved to a position near the body, the abutting portion abuts the top lid so that the top lid is switched to the closed state. When the brewing device is moved forward to a position away from the body, the top lid is disengaged from the abutting portion and the top lid is automatically switched to the opened state without having to be manually raised, thus enabling convenient operation.

### RELATED APPLICATION

This application is related to Chinese Patent Application Number CN2021106202223, filed on Jun. 3, 2021, the entirety of which is herein incorporated by reference.

### FIELD

The present application relates to a coffee maker.

### BACKGROUND

When a drip coffee maker is in use, heated water is poured over and seeps into coffee powder and absorbs its color and taste, wherein coffee is then poured into a coffee cup after filtration. The operation is simple, and drip coffee makers have therefore become widely popular among consumers. U.S. Pat. No. 4,759,274 discloses a drip coffee maker that requires manual raising of a lid of its brewing device to insert coffee powder before closing the lid. Its operation is not convenient, and the lid needs to be placed somewhere after being removed, where it is prone to becoming contaminated.

### SUMMARY

The present application provides an easy-to-operate coffee maker.

The present application provides a coffee maker comprising a body and a brewing device, wherein the body comprises an abutting portion, the brewing device comprises a receiving apparatus and a top lid movably assembled on the receiving apparatus, the receiving apparatus is provided with a receiving chamber, and the top lid is located above the receiving chamber. The body is provided with a water outlet, and the top lid is provided with a water inlet, wherein water flowing out of the water outlet of the body is introduced into the water inlet of the top lid and enters the receiving chamber. The brewing device is movable so that the top lid can be switched between the closed state and the opened state. When the brewing device is moved to a position near the body, the abutting portion abuts the top lid so that the top lid is switched to the closed state. When the brewing device is moved forward to a position away from the body, the top lid is disengaged from the abutting portion and the top lid is automatically switched to the opened state.

In some embodiments, while the coffee maker of the above technical scheme is in use, when the brewing device is moved to a position near the body, the abutting portion abuts the top lid so that the top lid is switched to the closed state. When the brewing device is moved forward to a position away from the body, the top lid is disengaged from the abutting portion and the top lid is automatically switched to the opened state without having to be manually raised, thus enabling convenient operation.

Further, the brewing device comprises a spindle and an elastic apparatus, the spindle being assembled with the receiving apparatus and the top lid, wherein when the top lid is in the closed state, the elastic apparatus is stressed and the elastic compressive force of the elastic apparatus is able to raise the top lid.

In some embodiments, the brewing device of the above technical scheme comprises an elastic apparatus to facilitate automatic opening of the top lid.

Further, the elastic apparatus comprises a torsion spring, with one end of the torsion spring abutting the top lid and the other end thereof abutting the receiving apparatus such that the top lid generates an opening force relative to the receiving apparatus.

In some embodiments, the elastic apparatus of the above technical scheme comprises a torsion spring, with one end of the torsion spring abutting the top lid and the other end thereof abutting the receiving apparatus such that the top lid generates an opening force relative to the receiving apparatus. It is structurally simple in this regard.

Further, the receiving chamber is provided with a plurality of longitudinal convex ribs disposed on the inner side thereof to support a cup filter placed in the receiving chamber, such that the cup filter can be conveniently placed in the receiving chamber when the top lid is in the opened state.

Further, the receiving chamber is provided with a mesh filter such that coffee powder can be directly put into the receiving chamber when the top lid is in the opened state.

In some embodiments, the receiving chamber of the above technical scheme is provided with a mesh filter and coffee powder can be directly put into the receiving chamber when the top lid is in the opened state, without provision of a cup filter to save cost, and thereby avoiding the complex processes of taking and placing cup filter to facilitate increased operational convenience.

Further, the coffee maker further comprises a guide rail and a bracket, the bracket being slidably attached to the body through the guide rail, the bracket sliding forward to the position away from the body or backward to the position near the body.

Further, the body comprises a first inclined portion configured to abut the top lid when the top lid is in the opened state, such that the top lid is limited to remain at an opening angle.

In some embodiments, the body of the above technical scheme comprises a first inclined portion configured to abut the top lid when the top lid is in the opened state, such that the top lid is limited to remain at an opening angle, thereby preventing the top lid from being opened too wide that may result in the top lid being blocked and the brewing device made immovable.

Further, the body comprises a second inclined portion connected to the first inclined portion and the abutting portion, the second inclined portion being located beneath the first inclined portion to guide the top lid to move to the bottom of the abutting portion.

Further, the second inclined portion is linearly shaped, wherein the angle of inclination between the second inclined portion and the horizontal is an acute angle, and wherein the angle of inclination between the first inclined portion and the horizontal is an acute angle.

Further, the brewing device comprises a handheld portion disposed at the receiving apparatus to facilitate pushing and pulling of the brewing device.

### BRIEF DESCRIPTION OF THE DRAWINGS

FIG. 1 is an isometric view of a coffee maker of an embodiment of the present application, wherein the top lid is in the closed state.

FIG. 2 is a top view of the coffee maker shown in FIG. 1.

FIG. 3 is a schematic sectional view of the coffee maker along line A-A shown in FIG. 2.

FIG. 4 is an enlarged view of a circled portion of the schematic sectional view shown in FIG. 3.

FIG. 5 is an isometric view of the coffee maker of the embodiment of the present application, wherein the top lid is in the opened state.

FIG. 6 is a top view of the coffee maker shown in FIG. 5.

FIG. 7 is a schematic sectional view of the coffee maker along line B-B shown in FIG. 6.

FIG. 8 is an enlarged view of a circled portion of the schematic sectional view shown in FIG. 7.

FIG. 9 is a schematic view of a cup filter of the embodiment of the present application.

FIG. 10 is a top view of the cup filter shown in FIG. 9.

FIG. 11 is a schematic sectional view of the cup filter along line C-C shown in FIG. 10.

### DETAILED DESCRIPTION

Here the exemplary embodiments will be described in detail with reference to the accompanying drawings. Unless otherwise stated in the description of the accompanying drawings, it is to be noted that same numerals represent the same or similar elements. The exemplary embodiments described below do not represent all embodiments consistent with the present application. On the contrary, they are merely examples of devices consistent with some aspects of the present application described in detail in the appended claims.

The terms used in the present application are merely intended to describe specific embodiments instead of limiting the present application. Unless otherwise defined, the technical or scientific terms used in the present application shall have ordinary meanings commonly understood by persons of ordinary skills in the art. The terms “first”, “second” and the like used in the description and claims of the present application do NOT indicate any sequence, quantity or importance, but are intended to identity different constituent parts. Similarly, words such as “one” or “a” also do NOT indicate quantity limits, but indicates the presence of at least one. “A plurality of” or “several” indicate two or more. Unless otherwise indicated, the terms “front section”, “rear section”, “lower section” and/or “upper section” and the like are merely intended for facilitating illustration, instead of limiting to a location or spatial orientation. The terms “comprises” or “includes” and the like are intended to refer to the components or items appearing before the words “comprises” or “includes”, including the components or items appearing after the words “comprises” or “includes” and their equivalence, and do NOT exclude other components or items. The terms “connect” or “link” and the like are not limited to physical or mechanical connections, and may include electrical connections, be they direct or indirect. Unless otherwise clearly defined by context, the singular forms “a”, “the” and “that” used in the description and claims of the present application are intended to include the plurals. It must also be understood that the words “and/or” used herein refer to and include any and all possible combinations of one or a plural number of associated listed items.

An embodiment of the present application provides a coffee maker comprising a body and a brewing device, wherein the body comprises an abutting portion, the brewing device comprises a receiving apparatus and a top lid movably assembled on the receiving apparatus, the receiving apparatus is provided with a receiving chamber, and the top lid is located above the receiving chamber. The body is provided with a water outlet, the top lid is provided with a water inlet, wherein water flowing out of the water outlet of the body is introduced into the water inlet of the top lid and enters the receiving chamber. The brewing device is movable so that the top lid can be switched between the closed state and the opened state. When the brewing device is moved to a position near the body, the abutting portion abuts the top lid so that the top lid is switched to the closed state, and when the brewing device is moved forward to a position away from the body, the top lid is disengaged from the abutting portion and the top lid is automatically switched to the opened state.

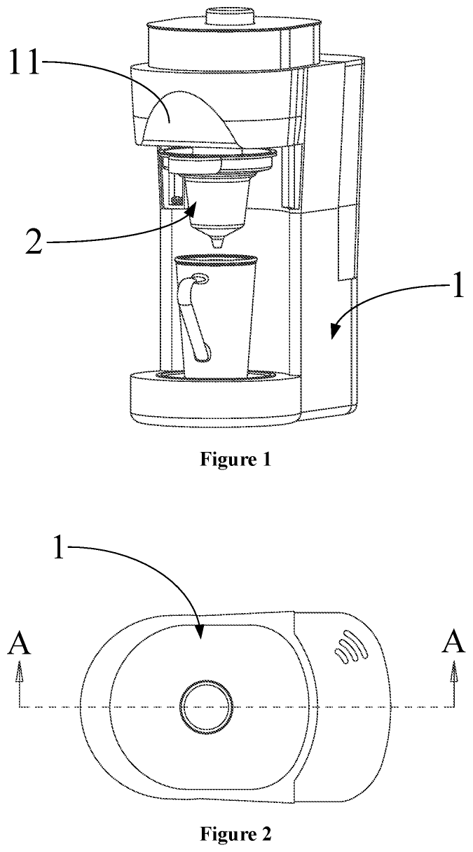

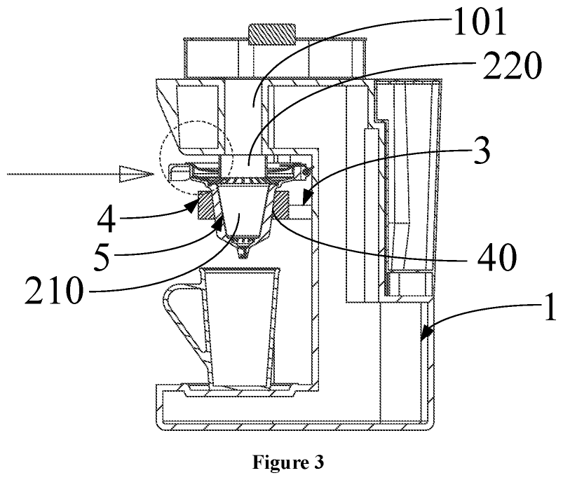

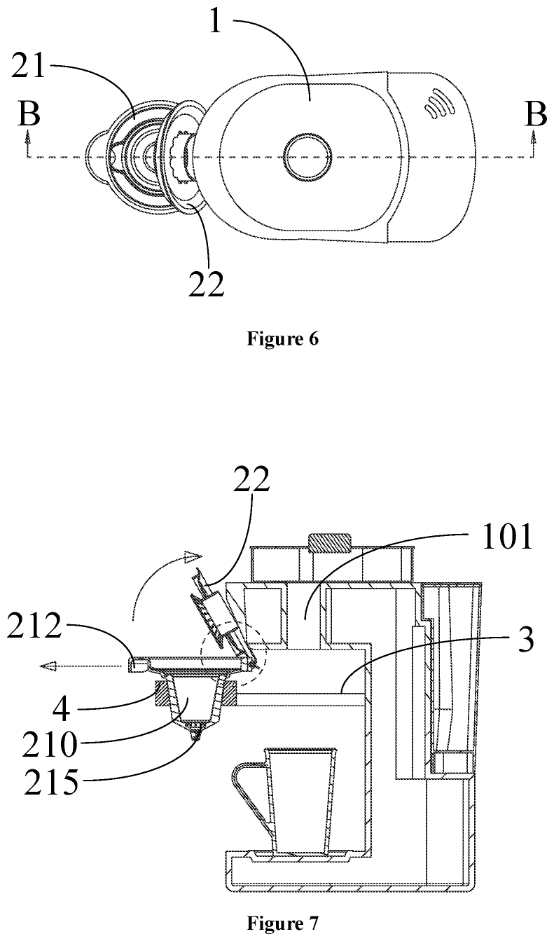

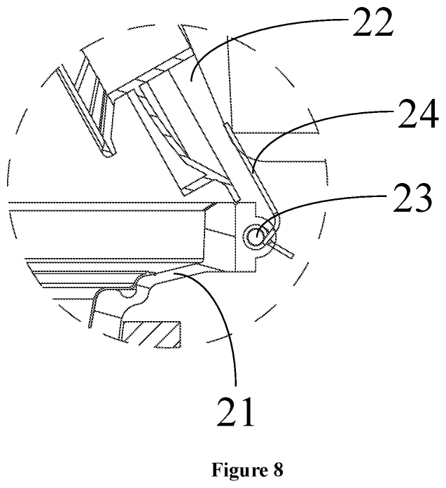

As shown in FIGS. 1 to 8, a coffee maker of an embodiment of the present application comprises a body 1, a brewing device 2, a guide rail 3, a bracket 4 and a cup filter 5. The guide rail 3 is connected to the body 1. The bracket 4 is slidably attached to the body 1 via the guide rail 3. The bracket 4 slides forward to the position away from the body 1 or slides backward to the position near the body 1. The bracket 4 comprises a through hole 40. The brewing device 2 is partially received in the through hole 40 such that the brewing device 2 can be supported by the bracket 4. The bracket 4 moves along the guide rail 3 to move the brewing device 2.

The brewing device 2 comprises a receiving apparatus 21 and a top lid 22 movably assembled on the receiving apparatus 21. The receiving apparatus 21 is provided with a receiving chamber 210. The cup filter 5 is placed in the receiving chamber 210. Coffee powder may be placed into the cup filter 5. The top lid 22 is located above the receiving chamber 210, and is provided with a water inlet 220. The body 1 is provided with a water outlet 101. When coffee needs to be brewed, the brewing device 2 is pushed toward the body 1 so that the water outlet 101 is located above the water inlet 220. Water flowing out of the water outlet 101 of the body 1 is introduced into the water inlet 220 of the top lid 22 and enters the receiving chamber 210 to brew coffee. When coffee powder needs to be added or coffee grounds needs to be removed, the brewing device 2 is pulled out for coffee powder to be added or coffee grounds to be removed.

The receiving apparatus 21 is provided with a plurality of longitudinal convex ribs 215 disposed on the inner side of the receiving chamber 210 to support a cup filter 5 placed in the receiving chamber 210. The cup filter 5 can be conveniently placed in the receiving chamber 210 when the top lid 22 is in the opened state. The receiving apparatus 21 can be further provided with a mesh filter in place of the cup filter 5, and coffee powder can be directly poured into it when the top lid 22 is in the opened state, without the step of placing the cup filter 5, thereby facilitating increased operational convenience and saving cost.

When the brewing device 2 is pushed in or pulled out, the top lid is switched between the closed state and the opened state. The body 1 comprises an abutting portion 10. When the brewing device 2 is moved to a position near the body 1, the abutting portion 10 abuts the top lid 22 so that the top lid 22 is switched to the closed state, at which time the water outlet 101 is located above the water inlet 220 to facilitate coffee brewing. When the brewing device 2 is pulled forward to a position away from the body 1, the top lid 22 is disengaged from the abutting portion 10 and the top lid 22 is automatically switched to the opened state, at which time coffee powder can be put in or coffee grounds removed. Thus, when the brewing device 2 is pulled out, the top lid 22 can be automatically opened, and when the brewing device 2 is pushed in, the top lid 22 is automatically closed. No manual operation is needed, making its use even more convenient.

The receiving apparatus 21 comprises a first base portion 211, a circular guard 213 extended from the first base portion 211 and a handheld portion 212 extended from the guard 213. Provision of the guard 213 prevents overflow due to excessive water. Provision of the handheld portion 212 facilitates pushing and pulling of the brewing device 2.

The brewing device 2 comprises a spindle 23 and an elastic apparatus 24. The spindle 23 is assembled with the receiving apparatus 21 and the top lid 22, so that the top lid 22 is connected to the receiving apparatus 21. When the top lid 22 is in the closed state, the elastic apparatus 24 is stressed. When the top lid 22 is disengaged from the abutting portion 10 of the body 1, the elastic compressive force of the elastic apparatus 24 is able to raise the top lid 22.

In the embodiment shown in the figures, the elastic apparatus 24 comprises a torsion spring, with one end of the torsion spring abutting the top lid 22 and the other end thereof abutting the receiving apparatus 21, such that the top lid 22 generates an opening force relative to the receiving apparatus 21.

The body 1 comprises a first inclined portion 11 located at one side of the abutting portion 10. The first inclined portion 11 is configured to abut the top lid 22 when the top lid 22 is in the opened state, such that the top lid 22 is limited to remain at an opening angle. The body 1 further comprises a second inclined portion 12 connected to the first inclined portion 11 and the abutting portion 10. The second inclined portion 12 is located beneath the first inclined portion 11 to guide the top lid 22 to move to the bottom of the abutting portion 10. The angle of inclination between the first inclined portion 11 and the horizontal is an acute angle to prevent the top lid 22 from being opened too wide, that may result in the top lid 22 being blocked and the brewing device 2 made immovable. The second inclined portion 12 is curved or may be linearly shaped, and the angle of inclination between the second inclined portion 12 and the horizontal is an acute angle.

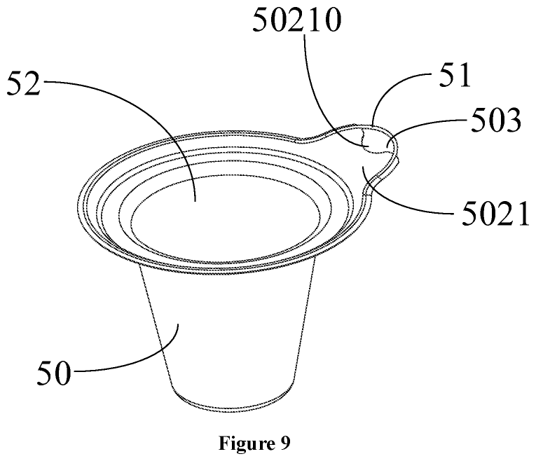

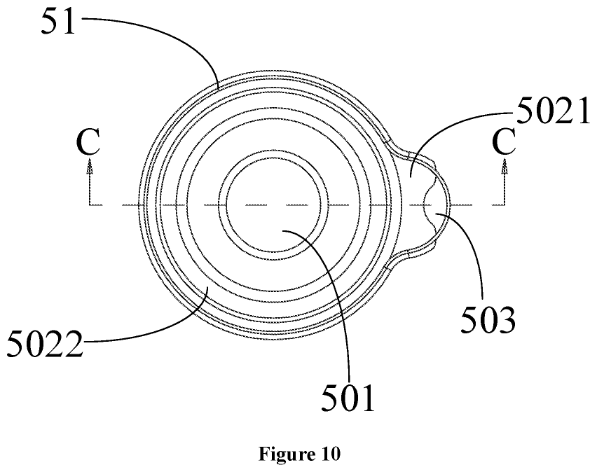

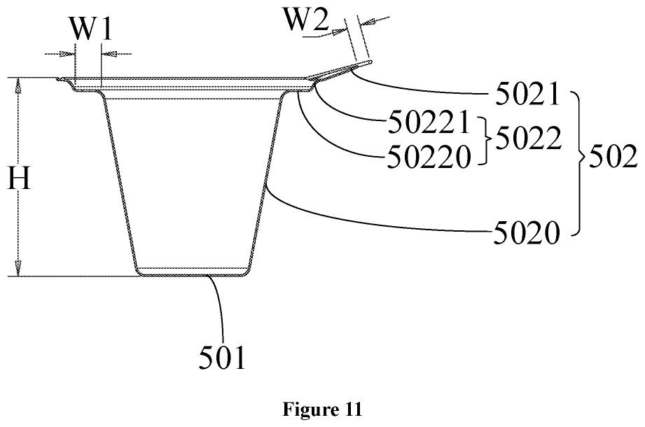

As shown in FIGS. 9 to 11, the cup filter 5 comprises a cup body 50 and a handle unit 51. The cup body 50 comprises a bottom 501 and a circular side wall 502 extended from the bottom 501. The height of the cup filter 5, H is larger than or equal to 20 mm and smaller than or equal to 100 mm, preferably larger than or equal to 40 mm and smaller than or equal to 80 mm, to receive more coffee powder. The cup filter 5 comprises a cup rim 52, the cup rim 52 having a diameter larger than or equal to 20 mm and smaller than or equal to 100 mm, preferably larger than or equal to 30 mm and smaller than or equal to 60 mm, to allow convenient placement of coffee powder.

The side wall 502 comprises a second base portion 5020, a connecting portion 5022 extended from the second base portion 5020, and a protruding ledge 5021 extended slantingly upward from the connecting portion 5022. The connecting portion 5022 comprises a first connecting portion 50220 extended from the second base portion 5020 and a second connecting portion 50221 extended from the first connecting portion 50220. The protruding ledge 5021 is connected to the second connecting portion 50221. The first connecting portion 50220 is extended outward along the horizontal direction from the second base portion 5020. The second connecting portion 50221 is first extended slantingly upward and then outward from the first connecting portion 50220.

The first connecting portion 50220 has a width W1 larger than or equal to 5 mm and smaller than or equal to 30 mm, preferably larger than or equal to 5 mm and smaller than or equal to 10 mm, so that the cup filter 5 is better supported when placed in the receiving apparatus 21 to prevent coffee powder from being spilled out. The side wall 502 may be without the connecting portion 5022, such that the protruding ledge 5021 is extended from the second base portion 5020. Or, the side wall 502 may be without the second connecting portion 50221, such that the protruding ledge 5021 is extended from the first connecting portion 50220.

The handle unit 51 comprises a strand that may be hot pressed or glued to the side wall 502 of the cup body 50. The handle unit 51 and the protruding ledge 5021 form an opening 503 to facilitate lifting and pulling of the handle unit 51. The protruding ledge 5021 is provided with a notch 50210, with the notch 50210 being included in the opening 503. The opening 503 has a width W2 smaller than or equal to 20 mm. The opening 503 has an area larger than or equal to 1 cm² and smaller than or equal to 100 cm².

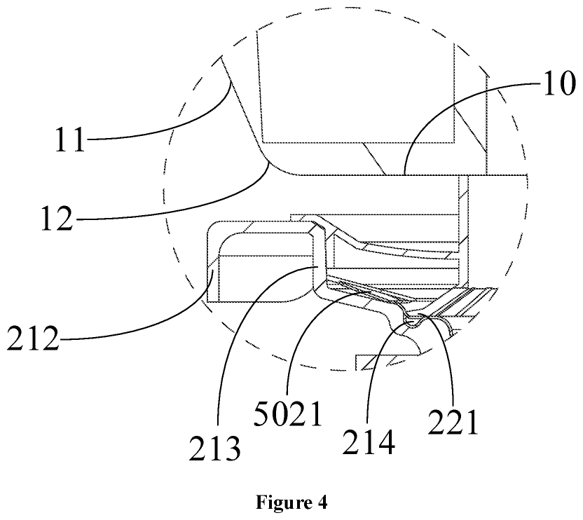

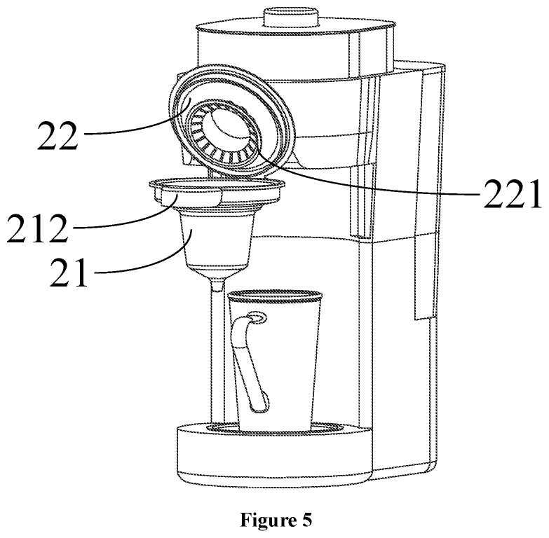

As shown in FIGS. 4 and 5, the top lid 22 comprises a downwardly protruding crimping portion 221. The guard 213 of the receiving apparatus 21 is provided with a recess 214. When the top lid 22 is closed, the crimping portion 221 crimps the cup filter 5 and the connecting portion 5022, such that the connecting portion 5022 is deformed toward the recess 214 and causes the protruding ledge 5021 of the cup filter 5 to tilt upward. When the top lid 22 is opened, the cup filter 5 can be removed.

While the coffee maker of the embodiment of the present application is in use, when the brewing device 2 is moved to a position near the body 1, the abutting portion 10 abuts the top lid 22 so that the top lid 22 is switched to the closed state, and when the brewing device 2 is moved forward to a position away from the body 1, the top lid 22 is disengaged from the abutting portion 10 and the top lid is automatically switched to the opened state without having to be manually raised, thus enabling convenient operation.

The foregoing merely describes preferred embodiments of the present application, instead of limiting it in any way. While preferred embodiments of the present application have been disclosed above, they are not intended to limit the present application. Any persons skilled in the art may contemplate equivalent embodiments by making some alteration or modification to the disclosure without departing from the scope of the present application. However, any alteration, equivalent change and modification made without departing from the spirit of the present application shall fall within the scope of protection thereof.

1. A coffee maker comprising:
a body; and,
a brewing device;
wherein the body comprises an abutting portion;
wherein the brewing device comprises a receiving apparatus and a top lid movably assembled on the receiving apparatus, the receiving apparatus being provided with a receiving chamber, and the top lid being located above the receiving chamber;
wherein the body is provided with a water outlet, the top lid is provided with a water inlet, and water flowing out of the water outlet of the body is introduced into the water inlet of the top lid and enters the receiving chamber;
wherein the brewing device is movable so that the top lid can be switched between the closed state and the opened state; and,
wherein when the brewing device is moved to a position near the body, the abutting portion abuts the top lid so that the top lid is switched to the closed state, and when the brewing device is moved forward to a position away from the body, the top lid is disengaged from the abutting portion and the top lid is automatically switched to the opened state.

2. The coffee maker of claim 1, wherein:
the brewing device comprises a spindle and an elastic apparatus, the spindle being assembled with the receiving apparatus and the top lid;
wherein when the top lid is in the closed state, the elastic apparatus is stressed and the elastic compressive force of the elastic apparatus is able to raise the top lid.

3. The coffee maker of claim 2, wherein:
the elastic apparatus comprises a torsion spring, with one end of the torsion spring abutting the top lid and the other end thereof abutting the receiving apparatus such that the top lid generates an opening force relative to the receiving apparatus.

4. The coffee maker of claim 1 wherein:
the receiving chamber is provided with a plurality of longitudinal convex ribs disposed on the inner side thereof to support a cup filter placed in the receiving chamber, such that the cup filter can be conveniently placed in the receiving chamber when the top lid is in the opened state.

5. The coffee maker of claim 1, wherein:
the receiving chamber is provided with a mesh filter and coffee powder can be placed directly into the receiving chamber when the top lid is in the opened state.

6. The coffee maker of claim 1, further comprising:
a guide rail and a bracket, the bracket being slidably attached to the body via the guide rail, the bracket sliding forward to the position away from the body or sliding backward to the position near the body.

7. The coffee maker of claim 1, wherein:
the body comprises a first inclined portion configured to abut the top lid when the top lid is in the opened state such that the top lid is limited to remain at an opening angle.

8. The coffee maker of claim 7, wherein:
the body comprises a second inclined portion connected to the first inclined portion and the abutting portion, the second inclined portion being located beneath the first inclined portion to guide the top lid to move to the bottom of the abutting portion.

9. The coffee maker of claim 8, wherein:
the second inclined portion is linearly shaped, the angle of inclination between the second inclined portion and the horizontal being an acute angle, and the angle of inclination between the first inclined portion and the horizontal being an acute angle.

10. The coffee maker of claim 1, wherein the brewing device comprises a handheld portion disposed at the receiving apparatus to facilitate pushing and pulling of the brewing device.
